(19) United States
(12) Patent Application Publication
(10) Pub. No.: US 2007/0150463 A1
(43) Pub. Date: Jun. 28, 2007

(54) Advanced method of searching, drafting and editing of electronic files

(76) Inventors: Claudio Cannella, Turin (IT); Salvatore Pappalardo, Rome (IT)

Correspondence Address: YOUNG & THOMPSON, 745 SOUTH 23RD STREET, 2ND FLOOR, ARLINGTON, VA, 22202, US

(21) Appl. No.: 10/583,940

(22) PCT Filed: Sep. 6, 2004
(86) PCT No.: PCT/IT04/00477

§ 371 Date: Jun. 22, 2006

(30) Foreign Application Priority Data
Dec. 22, 2003 (IT) RM2003A000589

(51) Int. Cl. G06F 17/30

(52) U.S. Cl. 707/5

(57) ABSTRACT

A method of searching, drafting and editing of electronic files includes the use of one or more peripheral computers, each computer handling an assembly of one or more updatable data bases having electronic documents, the electronic documents including information suitable to identify the same documents, each peripheral computer handling searches for, drafting of, communication about, and editing of, documents, the method being characterised in that the data base assembly provides one or more catalogues relevant to the documents, the search of documents or of part of documents being carried out employing at least one search criterium including the use of one or more catalogues. Apparatuses and instruments necessary for carrying out the method are also disclosed.

The present invention relates to an advanced method of searching, drafting and editing of electronic files.

More particularly, the method according to the invention allows to search electronic documents in specialised data base, within own files and/or in Internet, such as music, texts and videos, according to keys and taking into consideration the searches already carried out, as well as editing said documents in such a way to obtain final documents in a hypertext form, being sure to have paid the exclusive right fees for all the parts extracted from the published documents.

In the editorial field, distribution has a large incidence on the final cost of the commercialised work.

Furthermore, some times it is difficult a precise check of the payment of the copyright fees in case someone partially takes parts of different works. Such a control can be made at present only on works already transferred on a support.

However, in this field, we have today the possibility of a wide use of the computer and of the Internet.

However, solutions suggested up to now do not globally improve the situation, rather opening new, restricted market sectors.

The needing thus remains of method and tools able to exploit the informative resources in order to have a global managing of publishing, so as to reduce manufacturing costs and to offer to the authors the possibility of a quick introduction on the market and to the public a bigger offer with reduced costs.

Furthermore, public is interested in the possibility of making advanced searches of documents or of part of documents. However, said searches does not take into consideration the previous searches, i.e. leave in the search engines at most a statistic track and must be set again by each user, starting from the beginning in some cases after the lapsing of a connection session or at most after 24 hours.

Thus the needing remains of method and tools able to exploit the informative resources in order to carry out advanced searches by advanced search engines. These methods and instruments must be understood as making integral part of the industrial publishing and distribution process and thus have a full industrial character.

It is object of the present invention a method for searching, drafting and editing hypertexts, solving the above problems.

It is further specific object of the present invention that of providing apparatuses and instruments necessary for carrying out the method according to the invention.

It is object of the present invention a method of searching, drafting and editing of electronic files comprising the use of one or more peripheral computers, each computer handling an assembly of one or more updatable data bases comprising electronic documents, said electronic documents comprising information suitable to identify the same documents, each peripheral computer handling searches for, drafting of, communication about, and editing of, documents, the method being characterised in that said data base assembly provides one or more catalogues relevant to the documents, the search of documents or of part of documents being carried out employing at least one search criteria comprising the use of one or more catalogues.

Preferably, according to the invention, said one or more catalogues comprise a list of title of the documents.

Preferably, according to the invention, said one or more catalogues comprise a list of the contests for which the documents are available, including the titles of the contests.

Preferably, according to the invention, said one or more catalogues comprise the catalogue of the searches already carried out.

Preferably, according to the invention, said one or more databases provide pointers to a document collection.

Preferably, according to the invention, two search criteria are provided, a first search criteria being used in a first step A, a second criteria being used in a second step B to semantically analyse documents obtained from step A.

Advantageously, according to the invention, specialised dictionaries are employed in step B, relevant to specific contests and/or of the reference semantic assemblies relevant to the contests.

Advantageously, according to the invention, said assembly of one or more databases is identical for all the peripheral computers.

Advantageously, according to the invention, said information suitable to identify documents is text information.

Preferably, according to the invention, said documents are hypertext documents.

Preferably, according to the invention, the first step A is carried out by one or more hypertext search engines using said first search criteria.

Preferably, according to the invention, in the second step B, documents obtained from step A are semantically analysed up to a pre-set hypertextual level.

Advantageously, according to the invention, said first search criteria provides the use of keywords relevant to the content and/or the title of the documents, and/or the use of the definition of a contest, and/or the use of the number of the following surfing levels and/or the use of the identification of the search engines to be used.

Preferably, according to the invention, second search criterium at least partially uses the keys and the contest of the first search criteria.

Advantageously, according to the invention, search uses information relevant to the keywords and to the results of previous searches.

According to the invention, the method can further comprise the step of:

C. displaying the documents obtained in the first search step on a graphic user interface, said graphic interface comprising a first displaying window with the documents placed listed and a second window for drafting new documents.

Preferably, according to the invention, said one or more peripheral computers are connected to a server.

Preferably, according to the invention, one or more of said databases are stored within said server, said databases being updated on the peripheral computers.

Advantageously, according to the invention, first search criterium comprises GRID options.

According to the invention, method can further comprise the following step:

D. communication of the first search criteria from the peripheral computer to the server.

According to the invention, the method can further comprise the step of:

E. communication of the second search criteria from the peripheral computer to the server.

According to the invention, the method can further comprise the step of:

F. carrying out a first search by the peripheral computer, by consultation of a local catalogue of the search contests and of the already performed searches, as well as of the document addresses.

According to the invention, the method can further comprise the step of:

G. retrieving of the documents obtained in the first search by the server.

According to the invention, the method can further comprise the step of:

H. providing credential and keys, as well as inialization of communication channels by the server, suitable to enable the peripheral computer to p2p communications with other peripheral computers for retrieving and exchanging said documents.

Advantageously, according to the invention, p2p communications uses semi-private key cryptography.

According to the invention, a markup can be added to the retrieved documents, preferably a HTML markup.

According to the invention, the method can further comprise the step of:

I. carrying out an analyses of the documents according to said first search criteria by the peripheral computer.

According to the invention, the method can further comprise the step of:

J. carrying out an analyses according to said second search criteria of the documents discarded according to said first search criteria by the peripheral computer.

According to the invention, the method can further comprise the step of:

K. carrying out an analyses according to said second search criteria of the documents discarded according to said first search criteria by the server.

According to the invention, the method can further comprise the step of:

L. carrying out a search of new documents in the Internet by the peripheral computer or by the server.

According to the invention, the method can further comprise the step of:

M. analyses, by the peripheral computer, according to said first search criteria of the documents obtained during the surfing.

According to the invention, the method can further comprise the step of:

N. sending to the server the documents discarded during the analyses.

According to the invention, the method can further comprise the steps of:

N. analyses by the server of the documents discarded according to said second search criteria,

O. analysis by the server of the rejected documents according to said second search criterium.

According to the invention, the method can further comprise the step of:

P. displaying, by the peripheral computer, through the user interface, the documents obtained from the search.

Preferably, according to the invention, said documents obtained from the search are published on said peripheral computer.

Advantageously, according to the invention, the document(s) selected through the user interface are displayed on a window, and at the same time a window is displayed to modify the local documents and the access to local databases.

Preferably, according to the invention, final documents are drafted in the XML format.

According to the invention, the method can further comprise the step of:

Q. adding by the server and/or peripheral computer to one or more of said data bases, one or more new documents created on the basis of all or part of the documents obtained from the search.

Preferably, according to the invention, a document hypertext drafting mode can be selected by a user interface on the peripheral computer.

Advantageously, according to the invention, the list of the documents available for consultation and use is displayed.

According to the invention, one or more documents created on the basis of all or part of the documents obtained from the search can be published on the Internet.

Preferably, according to the invention a hypertext surfing mode can be selected by a user interface on the peripheral computer.

Preferably, according to the invention the hypertext surfing mode comprises the enabled of the automatic detection of the presence of the search keys and of the use of libraries.

Preferably, according to the invention a document search mode can be selected by a user interface on the peripheral computer.

Preferably, according to the invention, OLE-CLI libraries with reader function on all the not HTML and not XML documents are used.

It is further object of the present invention a user or client peripheral computer, characterised in that it carries out step A of the method according to the invention.

According to the invention, peripheral computer can carry out step B of the method according to the invention.

It is further specific object of the present invention a server, characterised in that it carries out step G of the method according to the invention.

It is further object of the present invention a computer program characterised in that it comprises code means suitable to carry out, when operating on a computer, step A of the search, drafting and hypertext editing method according to the invention.

According to the invention, computer program can comprise code means suitable to carry out, when operating on a computer, step B of the search, drafting and hypertext editing method according to the invention.

It is further object of the present invention a memory support readable by a computer, having a program memorised, characterised in that the program is the computer program according to the invention.

It is further object of the present invention a computer program characterised in that it comprises code means suitable to carry out, when operating on a computer, step G of the search, drafting and hypertext editing method according to the invention.

It is further specific object of the present invention a memory support readable by a computer, having a program memorised, characterised in that the program is the computer program according to the invention.

The present invention will be now described, for illustrative but not limitative purposes, according to its preferred embodiments, with particular reference to the figures of the enclosed drawings, wherein:

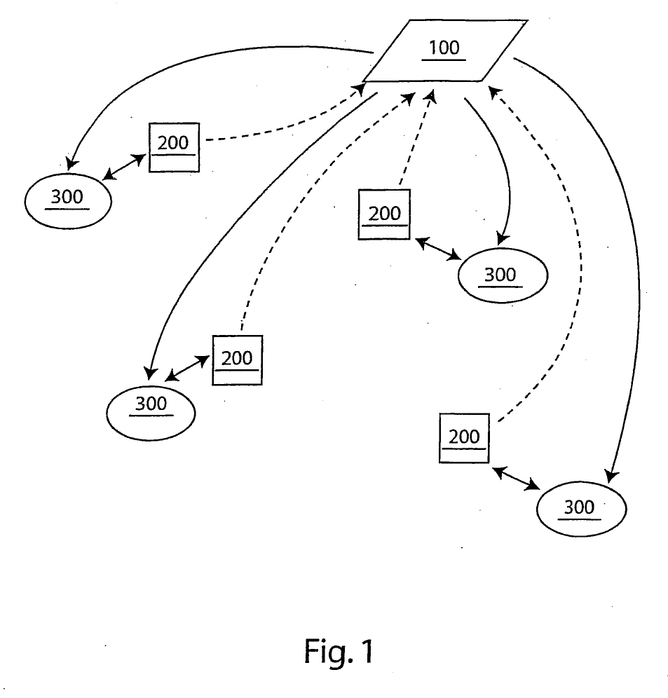

FIG. 1 shows the block diagram of a first preferred embodiment of the method according to the invention;

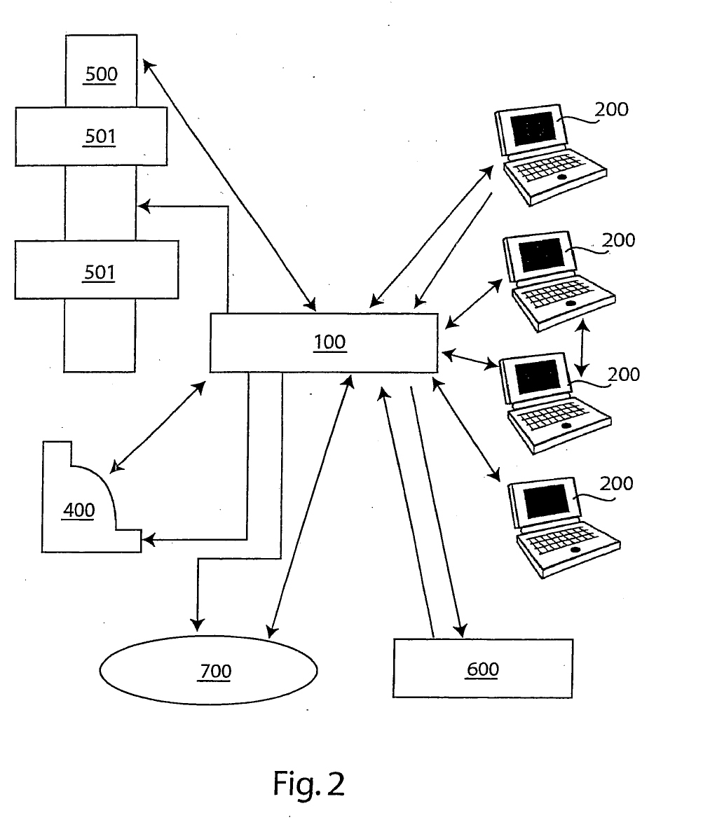

FIG. 2 shows the block diagram of a second preferred embodiment of the method according to the invention;

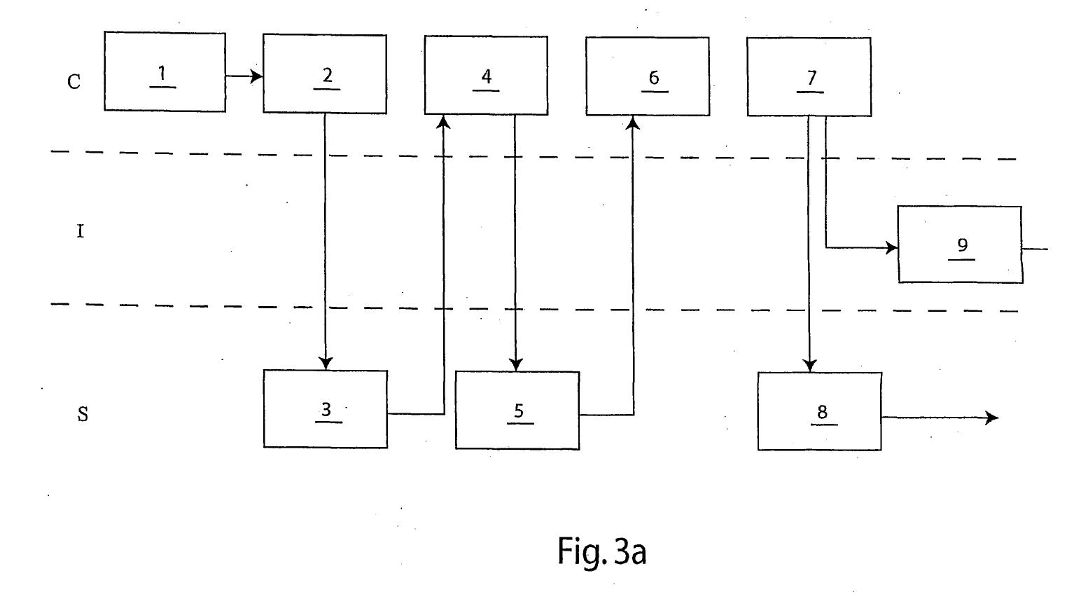

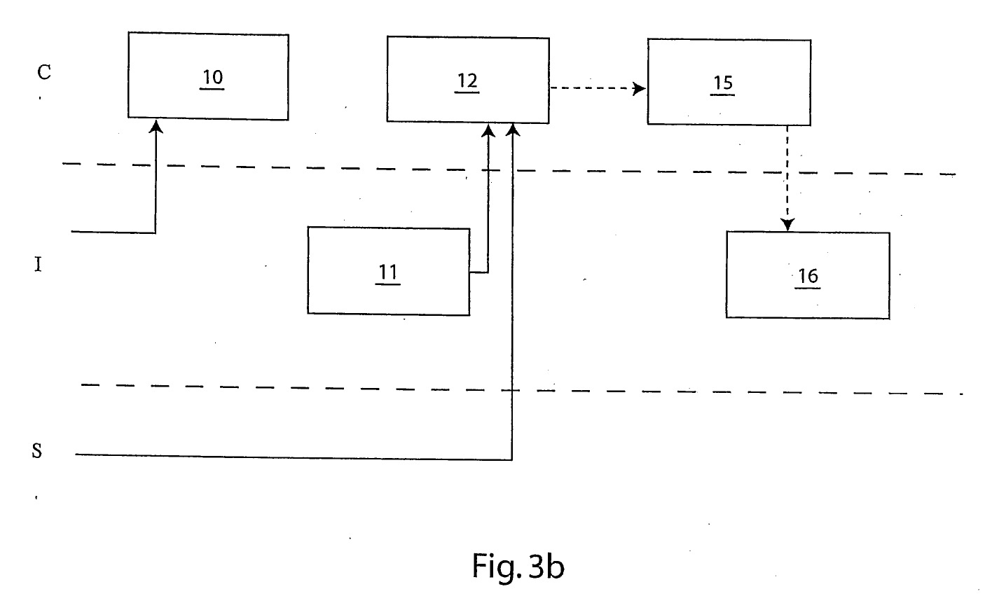

FIG. 3a shows the first portion of the flow chart of the second preferred embodiment of the method according to the invention;

FIG. 3b shows the second portion of the flow chart of the second preferred embodiment of the method according to the invention;

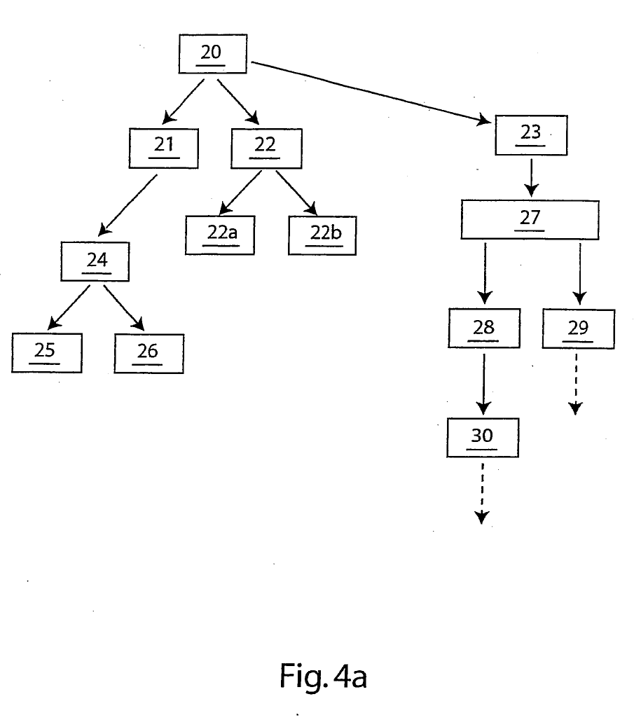

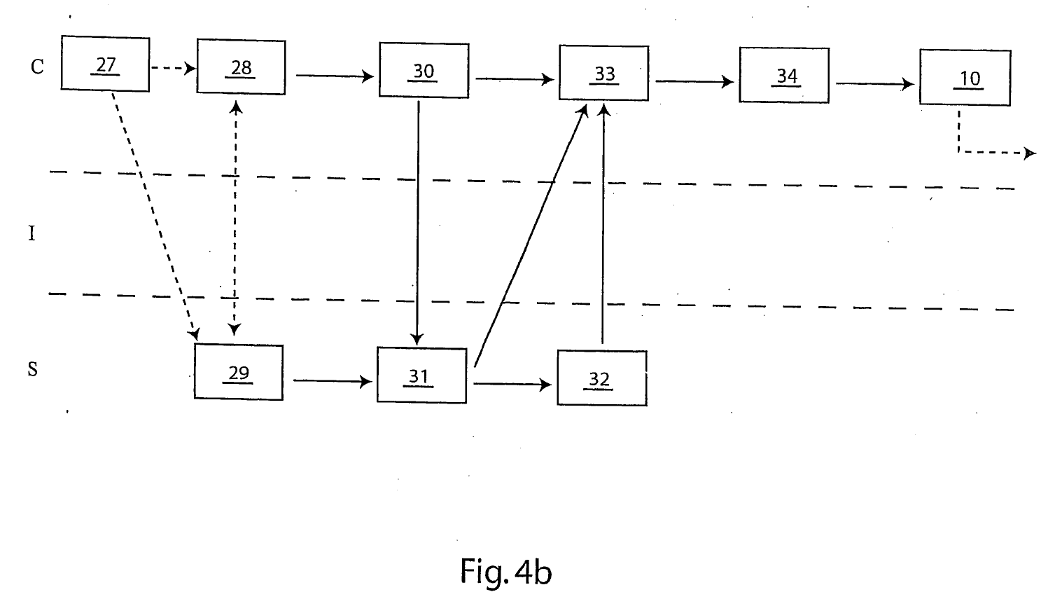

FIG. 4a shows the first portion of the flow chart of a third preferred embodiment of the method according to the invention;

FIG. 4b shows the second portion of the flow chart of the third preferred embodiment of the method according to the invention.

The method according to the invention will be in the following indicated as “meta-engine” since, among the others features, it carries out searches among the results obtained from Internet search engines such as Google and Yahoo!.

According to a preferred embodiment of the invention, as illustrated in FIG. 1, one or more peripheral computers 300 are provided, to which the user can have access. On each one of the peripheral computers one database 200 is provided, said database being updated by the provider 100 (see continuous arrows).

It must be evident that the method according to the invention operates also with a single peripheral computer, since the method does not require a particular number of computers, being it a general-purpose method. In this case, i.e. when a single peripheral computer is present, the method according to the invention only permits advanced searches, hypertext drafting and editing starting from the local databases.

Database refers to a collection of data (DC) by pointers. In this way data collection can be very compact, not being necessary that data are memorised in different “pages”, but one after the other.

For example, a general catalogue can be present in the database with the titles of the documents, said titles pointing to a specific portion of the DC content.

Data base can advantageously further comprise:

a list the treated contests,

contextualised dictionaries, i.e. specialised dictionaries relevant to specific contests;

semantic reference assemblies relevant to the contests,

catalogue of the searches already carried out,

list and raw text content of the already consulted pages,

hypertext drafting control sequence starting from the raw text,

user registry,

enabled user list,

list of enabled contests and the contest/user matching.

Updating of database and DC can occur by the periodic providing of a memorisation support containing the same data.

Thus the user can carry out searches and editing documents, either texts, music, videos or other data assemblies, comprising textual complementary information suitable for their identification.

User inputs search keys, and the search engine associated with the database carries out the search, examining the results by a semantic analyser to decide which are relevant to the input keys.

Finally, the user has the possibility of accepting or discarding those results of the second step not deemed to be relevant.

Search results are stored within the peripheral computer memory, said computer analysing them to provide information to the provider (dashed arrows) about the required and not found documents, so as the provider can update the data base inputting one or more already asked but not found documents.

In a second embodiment of the invention, database can also be in a “server”, to which the peripheral computers are connected.

In this case, meta-engine includes, at its basis, a peripheral module installed on the “Client” computer of each meta-engine user, along with:

a module for managing and cataloguing the stored documents and local users master, i.e. the master of the users accessing the peripheral computer;

a module for managing communications, on a communication protocol, relevant to the received, processed and/or sent material, and relevant to the processing methods,

a module for managing the peer-to-peer authenticated communications (p2p) between users and for counting quotations and crossed uses and the relevant intellectual property rights.

Searches are carried out delegating to the known search engines (such as Google and Yahoo!), to refine then the search among found files surfing up to set hypertextual levels.

Basic function of the meta-engine according to the first embodiment is that of “advanced textual editor” with communication from client to server (cts) and p2p, and output in HyperText Mark-up Language” (HTML) and extensible Markup Language (XML).

Selection of material and surfing of the hypertext links, as well as format conversion can be entrusted to a server, but it will be more convenient entrusted to the Client, as it will be described in the following.

Obtained pages are resident on Client, Server maintaining instead originals and assemblies of operations to create final documents.

Implementation of said functions occurs by some user graphic interfaces and by modules, that, with respect to the ISO-OSI architecture, cover presentation layers and application layers.

Communication with other modules of the Client package, as well as with the server and with p2p makes reference to a communication protocol.

Preferably, said communication protocol is a not standard protocol, according to the invention being really advantageous using a protocol different from the communication protocols available on the market.

Basic technological ideas for this approach are:

maintaining the document history,

centralisation of different functions and reduction of the size of the additional software installed outside the meta-engine, delegating the more standard functions to the existing packages,

use of p2p technology as well as of the Client-Server technology, separation of the formal textual information or “markup” (complementary information useful, for instance, to create a hypertextual document starting from the ASCII text) from the informative basic content (ASCII text) and evaluation of resulting documents,

use of proprietary communication protocols,

acquisition of documents locally created on the data base using techniques different from HTML/XML by the local use of readers or of the “Object Linking and Embedding” (OLE) Method, specialised, separated and locally present, and/or by the sending to the Server.

Making reference to FIGS. 3a and 3b, meta-engine during step 1 presents a first user interface for acquisition of searching criteria (prescinding from the other functionalities), followed by functionality of searching in the local copy of the catalogue of documents relevant to the already completed searches and of the searches under execution.

Thus, catalogue, in this specific case a network catalogue, i.e. a document shared by all the Clients to which the users can access, and is updated from the Server according to modes that can be set in the specific applications, e.g. by a Client control and relevant to the sole contest of last set search.

Client carries out a first search on said catalogue, as well as on all the documents to which it can have local access.

Search in step 2 is a specific keywords search, to which the use of contest keywords can follow. This kind of search is here referred as 1° level search.

In case something relevant to the searched matter emerges from the search carried out, it is presented to the user through a second interface and the user selects the one it prefers as basis asking it to the server (if it is not already present in locale), communicating with one or more different Clients, certifying the relevant authorisations to the communication and providing to all the involved Clients the keys for decrypting information, i.e. accredits for possible p2p communications.

Meanwhile, server carries out in a step 3 both a specific analyses on keys and an analyses of the contest, thus starting a second level analyses through the repeating of the first level search carried out by the Client.

Starting from the list of all the already carried out searches in the specific contest, it starts a search in the central catalogue and in the cache of the pages obtained from the previous searches.

This allows providing to the Client all the raw pages previously accepted for the chosen contest search; these pages are filtered again on the required keys (for example keywords and contest).

Second level analyses is carried out, for example, in case keys are words, looking at the frequency of these words and comparing said frequency with the frequencies characteristics for the chosen contest.

Now, in step 4, Client checks the index, which is common for all the Clients, of searches relevant to all the contests for which he is enabled, said index containing also Client address where physically are the information (documents) to be found.

Thus Client asks to the Server, during a step 5, to find said documents, if the user interrupted the working session with the server, or if the Client where the information must be found is not connected to the network. This is done to optimise the times.

Otherwise, server accredits the Client for p2p communication as specified in the above.

Once terminated these documents finding operations, during a step 6, Client receives all the documents found during the search, obviously those available, and naturally has available local information not yet shared on the network.

Now Client can carry out during a step 7 a first semantic analysis of the above-mentioned documents and information, using the above specific and contest keywords, and this can be done for all the contests in such a way to make an “exhaustive” search.

Said second semantic analyses includes the application of matrix, stylometric and statistic methods, such as the use of all the contests known to the server, control of each available document of words being part of the same contest, and the use of stylometric classes (occurrence frequencies and length of the words).

Documents that are thus deemed pertinent are transmitted to the Client, that, during a step 12, adds them to those already chosen and subjects the assembly of said documents to the user's selection.

At the same time of the second level analyses of step 8, another operation can be carried out during a step 9, in this case by the Client.

Said step 9 operation is a new search in the Internet of new documents according to the input search criteria. Search is delegate to the standard Internet search engines.

Results of this further search are transferred to a first semantic analyses, carried out by the Client during step 10, and then to a 2nd level semantic analyses, carried out by the Server during step 11.

During said 2nd level analyses, pages obtained from said searches are navigate by the Server at least up to link 10 level and are semantically analysed on text and contest keys to establish if pages are relevant or not, to be then suggested to the user as blocks, preferably of about 1 megabyte or 20 URL, containing pages at the first link level and connected by links up to the maximum permitted level or up to the level where no more links are present.

Finally, thus selected documents are suggested to the user during step 12 for final selection. He/she can accept or can refuse pages both at the abstract level, created by the same meta-engine employing specific algorithms, or at the full text level.

Abstract is created by a markup analyses and by comparison with documents of the same contest. It is also possible to make use of frequency criteria of the words according to the contest or, more roughly, to the extraction of the first n words (usually between 20 and 50) from the textual contest of the document found.

It is clear that other criteria can be added to the above ones, such as the presence of contest keywords or the average length of the words, as well as the bibliographic references. Abstract creation procedure is indicated as “abstracting”.

Now, the user can notify that he/she stops the search. In case of interruption, server sends to the Client all the documents already found.

Finally, user can intervene on the final document, making his/her modifications.

Accepted pages are transferred to the true editor, that during step 15 handles the content on order modifications, i.e. standard drafting operations allowing at the end to add a HTML markup or another program supporting the pure text scripting, thus creating control sequences relevant to the carried drafting operations and data allowing to regenerate the result starting from the original data.

Obviously, it is possible to save pages directly on the hard disk and then editing the same outside the advanced editor program by any program chosen by the user and sharing or not the final result.

In case of publication, Client sends the final edited XML document to the Server, said server publishing it in step 16.

It is to be added that, from peer-to-peer, beside the required documents, directly managed by the Client module, but not necessarily by the user presence, through which the users can exchange both other not catalogued documents, and observations and discussions, that can be shared and/or interconnected with other documents on demand.

In a third embodiment of the meta-engine, it further comprises:

full functionality of hypertextual surfer or “browser”;

functionality of removal of HTML instructions or “HTML stripping”;

cryptography, preferably with a semiprivate key;

introduction of “GRID” functions in the communication protocol, finalised to the transmission of semifinished data assemblies by the different peripheral computers toward the Server (to reduce the server work, each client carries out before hand a part of the second level analyses);

all OLE-CLI and OOP libraries relevant to the main applications (such as, for example, Word, Excel, Adobe, Macromedia, Flash and Director) link-edited in a static way or as Dynamic Link Libraries) (DDL);

possibility of memorising the whole in a XML database or on the server or on the Client to be able to re-use the information and parcel out the counting of the citations and of the uses, and to have direct access to the OLE libraries of Adobe PDF for print drafting and editing.

Each one of these performances is realised by a module locally operating on the Client and, when it is necessary, calls the “listener” asp/php of the server to transmit or to receive blocks of request or of data.

Within the Client package it is also present a compression/expansion LZ module.

Making reference to FIGS. 4a and 4b, meta-engine has four use modes:

editor,

search,

extended “surfing”, where link chains are automatically surfed,

simplified surfing, wherein link chains are not automatically surfed, but time by time after a control from the user.

Thus, meta-engine full use procedure (that will have to support the multi-allocation on independent windows beside tabbing) is as follows:

during a step 20, from the first interface, user chooses if using it according to a search mode activating step 23, editor mode activating step 21, or surfing, activating step 22; surfing could be extended (multiclass documents—i.e. documents recalling various modules handling different classes—markup, stripping and tabbing) or simplified (that will be the sole available mode if the program is called replying to a HTML, XML or Java link, requested by another program);

in case user has chosen:

editor mode, in step 21 the user sets a local path, or the title, or the number of a search; in step 22 a document list is presented to the user, the not complete documents first and the last one edited first; after his/her choice, during step 25, required document is delivered open in a window on the left side and a hypertext connection button or “tab” for each block not completely used as yet for listing the blocks, while during the contemporaneous step 26 a window on the right is opened, said right window having also the possibility of reading local documents drafted in any format and to catalogue within the data base (DB) and include them in the data collection (DC);

Simplified surfing mode, in step 22a the user sets a wed address, component enables HTML links in such a way that pages can be open in the same window or in a different window, using the OLE-CLI libraries only as reader function for all the not HTML and not XML documents (in case of Unix, since the syntactic analyser or “parser” XML cannot be integrated, XML will be considered as external format);

Extended surfing mode, during step 22b the user sets a web address; automatic revealing of presence of keywords is enabled and OLE-CLI libraries are used also for markup, stripping and abstracting;

Search mode, during step 27, the user sets the search keywords; a second interface is suggested, wherein the contest, the possible title, the number of depth levels, GRID options and engines to be interrogated, are chosen.

In case of the search, further important steps are present:

in a step 28, it is interrogated a local search catalogue and document contest indicated on the basis of keywords and of the possible title and a third interface can be proposed with a list of titles during a step 30; at the same time

in a step 29 the assembly of parameters is communicated to the server through packages updating the locale catalogue and the possible results are added to the user interface,

if in step 30 documents already included in the catalogue are chosen,
in step 31 the server
gets from the network the found documents,
authenticates and accredits p2p documents for receiving original documents and the different sections, taking note of those not available,
extracts documents from data base sending to the Client control sequence for composition of documents,
extracts from the cache all the pages not available on the network, which were part of the previous final document,
updates the cache copies of all that is still public and available by a comparison method, so that in case of excessive modifications, a new “Uniform Resource Locator” URL is generated, sending then the relevant updating controls to the catalogue,
sends to the Client all the parts resulting not publicly available or too much modified of the identified documents in the compressed and encrypetd document of its library (cache copy),
according to set GRID parameters, starts or not the searching of new material in a further step 32 on the engines or prepares a transparent process to the system supervisor/“thread” listener and semantic analyst for what returns to the Client,

on its side, client meta-engine
during step 33, activates different p2p connections discharging material, opening a tab for each block, decompressing and decrypting the whole at the moment of displaying,
if it has chosen to locally carry out GRID advanced functions, during a step 34,
activates searches on engines,
autonomously surfs the link chains,
analyses at the first level pages obtained from the previous chains and searches, and
for those accepted, communicates the summary markup and processed content to the server,
those rejected are wholly sent natively to the server for further analyses levels,
handles the editorial operations carried out on the documents by the user.

When he does not want any more material, the user pushes a suitable button on the interface thus interrupting the searches (both its own and the one of the server); however, the server in any case sends all those pages which both are already finished and have passed the more inner semantic analysis levels, updates the data bases and de-activates a specific thread listener, thus interrupting the searches.

For completion of the final document, the user inserts the markup closing the thread Clients, Client notifies the server and then puts the document, or does not put the document, for free catalogue or for payment consultation. Thread Clients toward inside (as for example those relevant to the drafting) depend on the presence of the user, those outside (as for example those relevant to the finding in the Internet of the documents) not, all being resumable at the last registered point in case the Client is switched off.

Pages passing the semantic examination at the first Client level (from now on reference is made to the flow chart of the second realisation step, starting from step 10, diagram not repeated in FIGS. 4a and 4b) and are discarded from the user, are sent natively to the server to go to further automatic analyses and eventually not automatic levels.

In case of acceptance at the subsequent analyses levels (for example determined by the belonging to the acceptable stylometric classes or by the belonging to link chains wherein accepted pages or in any case potentially acceptable pages are present), server proposes again them to the user in the following blocks, otherwise passes them to a not automatic analyses.

Once terminated the drafting of the new search document, the user can decide whether publishing it or not, and further can, for certain arguments, require a monitoring of a quarterly, semestral or annual duration of the new documents, as well as a count of the citations declared and of those implicit, and eventually of copies.

The present invention has been described for illustrative but not limitative purposes, according to its preferred embodiments, but it is to be understood that modifications and/or changes can be introduced by those skilled in the art without departing from the relevant scope as defined in the enclosed claims.

1-56. (canceled)

57. Method of searching, drafting and editing of electronic files comprising the use of one or more peripheral computers or clients and a central computer or server, each client handling an assembly of one or more databases, which refer to one or more datacollections by pointers and are updatable by the server and comprise electronic documents, said electronic documents comprising information suitable to identify the same documents, said databases assembly comprising one or more catalogues relevant to the documents, the method being characterised in that the final documents obtained by the search or drafted on its basis are resident on client, the server maintaining instead originary data content, mark-up and commands for re-composing such final documents, the databases assembly comprising a history catalogue of the searches already carried out for each context by any client and an index of physical locations of documents, the index being updated by the server, the method executing the following steps:
A. a Search step, in which:
A.1 the client performs a first-level search in the local copy of said history catalogue for the relevant context, and optionally
A.2 the server performs a second-level search in said history catalogue and in the cache of pages obtained in previous searches by any client;
B. a documents Retrieval step, in which:
B.1 the client searches the location of the documents, found in step A, in said index of physical locations of documents,
B.2 the client asks the documents to the clients to which they belong, by a p2p communication accredited by the server, or
B.3 the client asks the server to re-generate the documents, using originary data content, mark-up and commands;
C. a step of Semantic Analysis of the Results, in which
C.1 the client performs a first-level semantic analysis on the results obtained in step B, and optionally
C.2 the server performs a second-level semantic analysis on the results rejected by the analysis of the client;
D. a step of Storing and Updating, in which the server stores the results of the search, included the documents drafted later on their basis, in the form of composition commands and originary data content and mark-up, the server periodically updating all said catalogues, databases assembly and datacollections and said index of physical location of documents using the information relevant to the performed search.

58. Method according to claim 57, characterised in that said one or more catalogues comprise a list of title of the documents.

59. Method according to claim 57, characterised in that said one or more catalogues comprise a list of the contexts for which the documents are available, including the titles of the contexts.

60. Method according to claim 57, characterised in that a first search criterium is used in step A.1 and a second search criterium is used in step A.2, both criteria using keywords and contexts.

61. Method according to claim 60, characterised in that said second search criterium is established by the server taking into account said first search criterium.

62. Method according to claim 60, the semantic analysis of step C.1 utilises the search criterium of step A.1.

63. Method according to claim 60, characterised in that, in step C, it employees specialised dictionaries relevant to specific contexts and/or reference semantic assemblies relevant to the contexts.

64. Method according to claim 57, characterised in that said assembly of one or more databases is identical for all the clients.

65. Method according to claim 57, characterised in that said information suitable to identify documents are text information.

66. Method according to claim 57, characterised in that said documents are hypertext documents.

67. Method according to claim 66, characterised in that step A is carried out by one or more hypertext search engines.

68. Method according to claim 66, characterised in that, in step C, documents obtained from step A are semantically analysed up to a pre-set hypertextual level.

69. Method according to claim 60, characterised in that said first search criterium provides the use of keywords relevant to the content and/or the title of the documents, and/or the use of the definition of a context, and/or the use of the number of the following surfing levels and/or the use of the identification of the search engines to be used.

70. Method according to claim 57, characterised in that semantic analysis of step C comprises an “abstracting” step.

71. Method according to claim 67, characterised in that documents are analysed in step C at least up to the third hypertextual level.

72. Method according to claim 71, characterised in that documents are analysed at least up to the fifth hypertextual level.

73. Method according to claim 67, characterised in that the method further comprises the step A.3, in which the client displays the documents obtained in step A on a graphic user interface, said graphic interface comprising a first displaying window with the documents placed listed and a second window for drafting new documents.

74. Method according to claim 57, characterised in that first search criterium comprises GRID options.

75. Method according to claim 57, characterised in that p2p communications use semi-private key cryptography.

76. Method according to claim 75, characterised in that a markup is added to the retrieved documents.

77. Method according to claim 76, characterised in that the markup is a HTML or XML markup.

78. Method according to claim 57, characterised in that it further comprises a step C.3, subsequent to step C.1, in which the client carries out a search of new documents in the Internet.

79. Method according to claim 78, characterised in that it further comprises a step C.4, subsequent to step C.3, in which the client analyses, according to said first search criterium, the documents obtained during the surfing.

80. Method according to claim 79, characterised in that it further comprises a step C.5, subsequent to step C.1, in which the client sends to the server the documents rejected during the analysis of C.1, the server analysing in step C.2 such rejected documents.

81. Method according to claim 57, characterised in that it further comprises a step E in which the documents obtained from the search are displayed by the client through a user interface.

82. Method according to claim 81, characterised in that said documents obtained from the search are editable on said client.

83. Method according to claim 82, characterised in that the document(s) selected through the user interface are displayed on a window, and at the same time a window is displayed to modify the local documents and the access to local data bases.

84. Method according to claim 82, characterised in that final documents are drafted in the XML format.

85. Method according to claim 57, characterised in that one or more documents created on the basis of all or part of the documents obtained from the search can be published on the Internet.

86. Method according to claim 66, characterised in that OLE-CLI libraries with reader function on all the not HTML and not XML documents are used.

87. User or client peripheral computer, characterised in that it carries out step A.1 and/or B and/or C.1 of the method according to one of the claim 57.

88. Server computer, characterised in that it carries out step A.2 and/or C.2 and/or D of the method according to claim 57.

89. Computer program characterised in that it comprises code means suitable to carry out, when operating on a computer, step A.1 and/or B and/or C.1 of the search, drafting and hypertext editing method according to claim 57.

90. Memory medium readable by a computer, having a program stored on it, characterised in that the program is the computer program according to claim 33.

91. Computer program characterised in that it comprises code means suitable to carry out, when operating on a computer, step A.2 and/or C.2 and/or D of the search, drafting and hypertext editing method according to claim 57.

92. Memory support readable by a computer, having a program stored on it, characterised in that the program is the computer program according to claim 91.
